(19) United States
(12) Patent Application Publication
(10) Pub. No.: US 2025/0041901 A1
(43) Pub. Date: Feb. 6, 2025

(54) DRYER INLET ASPIRATOR

(71) Applicant: AG GROWTH INTERNATIONAL INC., Winnipeg (CA)

(72) Inventor: Dan KILLPACK, Minden, IA (US)

(73) Assignee: AG GROWTH INTERNATIONAL INC., Winnipeg (CA)

(21) Appl. No.: 18/363,067

(22) Filed: Aug. 1, 2023

(51) Int. Cl. B07B 4/08; B07B 4/02; F26B 25/00

(52) U.S. Cl. CPC B07B 4/08; B07B 4/02; F26B 25/002; F26B 25/007; F26B 2200/06

(57) ABSTRACT

A dryer inlet aspirator for pre-cleaning grain, including an aspirator housing; an air inlet and an air outlet formed in the housing, for distributing an air stream through the aspirator; a grain input and a grain output formed in the housing. The aspirator also includes a main distribution plate for guiding a stream of the grain in a first direction within the aspirator; and a lower distribution plate beneath the main distribution plate, positioned at an angle relative to the main distribution plate to receive the stream of the grain and further guide the stream of the grain in a second direction within said aspirator. A lower edge of the main distribution plate is spaced from the lower distribution plate to constrict the flow of the stream of the grain from the main distribution plate to the lower distribution plate.

### FIELD

This disclosure relates to a grain dryer system, and in particular to a dryer inlet aspirator for pre-cleaning grain before it enters the dryer chamber of a grain dryer.

### BACKGROUND

Grain dryer systems receive grain from filling equipment and remove moisture from the grain. Removing moisture may involve heating the grain. In mixed-flow grain dryer systems, the grain may be heated and cooled.

Removing material other than grain prior to grain entering the grain dryer can improve drying efficiency, reduce fugitive dust emissions leaving the dryer, and potentially reduce the likelihood of hazardous conditions forming during the drying process.

Some existing grain dryer systems are fed by a hopper without pre-cleaning functionality, such that material other than grain is not removed from the grain prior to the grain entering the grain dryer.

Other existing grain dryer systems attempt to solve these problems with standalone aspirators for pre-cleaning the grain. These aspirators are connected to the inlet of the grain dryer or hopper and typically increase the vertical height and thus installation cost of the overall grain dryer system.

Generally, these aspirators require grain to be “free flowing” through the system, requiring filling equipment to monitor and modulate the input grain.

Pre-cleaning systems are typically connected to an air source, such as a blower. These pre-cleaning systems may also cause grain to be inadvertently sucked out of the aspirator with dust and other unwanted particles. This can lead to reduced profits and premature blower damage or failure.

Accordingly, there is a need for an improved dryer inlet aspirator.

### SUMMARY

Aspects of the present disclosure relate to a dryer inlet aspirator for pre-cleaning grain. The dryer inlet aspirator includes an aspirator housing; an air inlet and an air outlet formed in the aspirator housing, for distributing an air stream through the dryer inlet aspirator; a grain input formed in the aspirator housing, for the grain to enter the dryer inlet aspirator; and a grain output formed in the aspirator housing, for the grain to exit the dryer inlet aspirator. The dryer inlet aspirator also includes a main distribution plate for guiding a stream of the grain in a first direction within the dryer inlet aspirator; and a lower distribution plate beneath the main distribution plate, positioned at an angle relative to the main distribution plate to receive the stream of the grain and further guide the stream of the grain in a second direction within the dryer inlet aspirator. A lower edge of the main distribution plate is spaced from the lower distribution plate to constrict the flow of the stream of the grain from the main distribution plate to the lower distribution plate.

Other aspects relate to a dryer inlet aspirator for pre-cleaning grain. The dryer inlet aspirator includes an aspirator housing; an air inlet and an air outlet formed in the aspirator housing, for distributing an air stream through the dryer inlet aspirator; a grain input formed in the aspirator housing, for the grain to enter the dryer inlet aspirator; and a grain output formed in the aspirator housing, for the grain to exit the dryer inlet aspirator. The dryer inlet aspirator also includes a bypass airstream assembly disposed at the air outlet, the bypass airstream assembly including a secondary air inlet connected to the air outlet; and a secondary air outlet disposed opposite the secondary air inlet, the secondary air outlet connected to an air source. The bypass airstream assembly also includes an air velocity adjustment baffle. The air velocity adjustment baffle is adjustable between a raised position and a lowered position. The bypass airstream assembly further includes bypass air slots disposed beneath the air velocity adjustment baffle for introducing a bypass airstream into the bypass airstream assembly.

Other features will become apparent from the drawings in conjunction with the following description.

### BRIEF DESCRIPTION OF DRAWINGS

FIG. 1A is a perspective view of a representative known grain dryer system;

FIGS. 1B-1C are perspective views of a grain dryer system according to some embodiments;

FIG. 2 is a perspective view of an inlet assembly from the grain dryer system of FIGS. 1B-1C;

FIGS. 3-4 are perspective views of a dryer inlet aspirator from the inlet assembly of FIG. 2;

FIG. 5 is a cross-section of the dryer inlet aspirator of FIGS. 3-4;

FIGS. 6A-6B are a cross-section and perspective view of distribution plates in the dryer inlet aspirator of FIGS. 3-4;

FIG. 7 is a cross-section of the distribution plates of FIGS. 6A-6B including an adjustable plate;

FIG. 8 is a cross-section of the dryer inlet aspirator of FIGS. 3-4 filled with grain according to a downspout setup;

FIG. 9 is a cross-section of the dryer inlet aspirator of FIGS. 3-4 filled with grain using an auger or conveyor;

FIG. 10 is a cross-section of the dryer inlet aspirator of FIGS. 3-4 modulating a bypass air path;

FIGS. 11A-11B are perspective views of the dryer inlet aspirator of FIGS. 3-4 modulating a bypass air path;

FIG. 12 is a cut-away view of the dryer inlet aspirator of FIGS. 3-4 including spreader baffles;

FIGS. 13A-13B are top-down views of the dryer inlet aspirator of FIG. 12;

FIGS. 14A-14B are perspective views of the distribution plates of the dryer inlet aspirator of FIG. 11; and

FIG. 15 is a cross-section of the grain dryer system of FIGS. 1B-1C.

### DETAILED DESCRIPTION

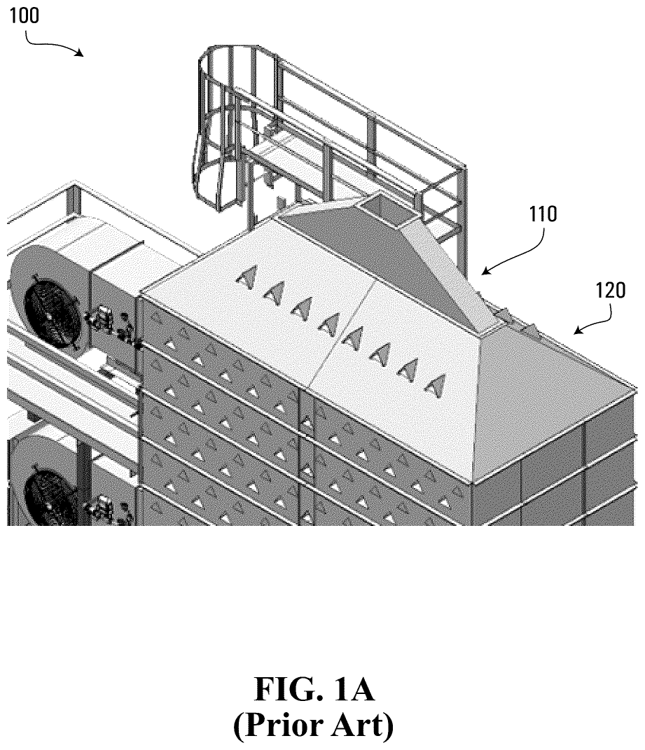

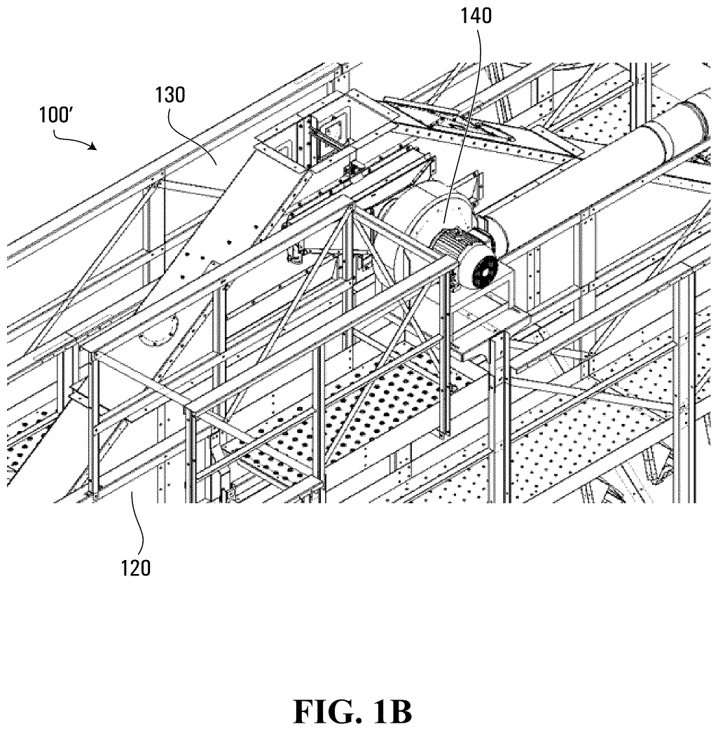

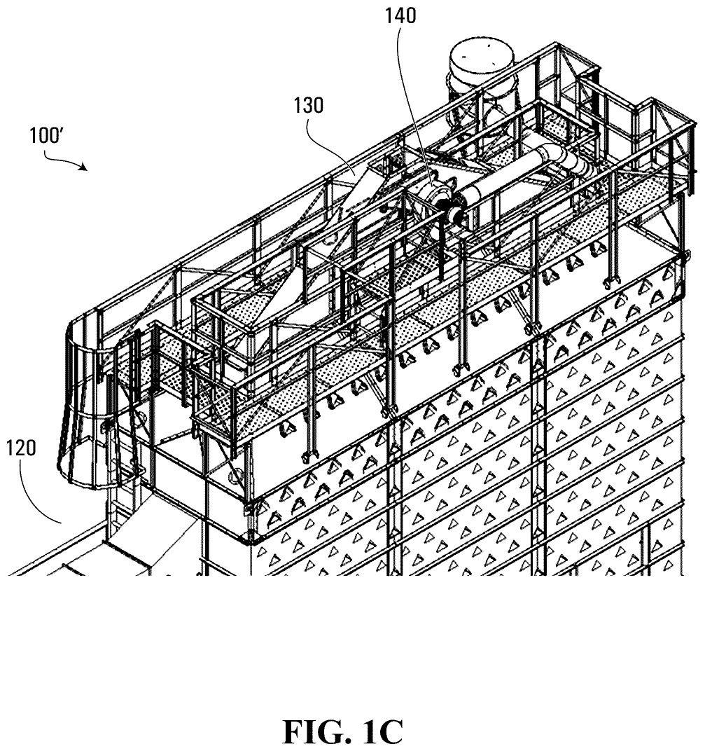

FIG. 1A is a perspective view of a representative known dryer system 100, which includes a hopper 110 mounted to a roof of a grain dryer 120. Grain is fed into hopper 110 by filling equipment (not shown) and deposited into roof of grain dryer 120. Roof of grain dryer 120 may also be referred to as the holding bin of grain dryer 120, and is the portion of grain dryer 120 that grain must pass through before it enters the dryer columns within grain dryer 120. Wet grain in the roof of grain dryer 120 is fed into the dryer columns of grain dryer 120 by gravity. An inlet into grain dryer 120 is located on roof of grain dryer 120.

Hopper 110 is typically a gravity fill hopper.

In some further representative known dryer systems, an external aspirator with grain pre-cleaning capabilities may first be connected to hopper 110 or other filling equipment.

FIGS. 1B-1C are perspective views of a dryer system 100′ according to some embodiments. Dryer system 100′ includes grain dryer 120, inlet assembly 130 and air source 140. Inlet assembly 130 is mounted to a roof of grain dryer 120, such that inlet assembly 130 is integrated with the inlet of grain dryer 120. Dryer system 100′ may be otherwise identical to dryer system 100.

Due to the similar longitudinal cross-section of inlet assembly 130 to gravity fill hopper 110, it will be appreciated that inlet assembly 130 may be mounted onto grain dryer 120 without increasing the overall height of dryer system 100′ relative to dryer system 100.

Air source 140 may be a blower for generating air flow or an air stream within inlet assembly 130. A cyclone separator may also be connected to the discharge of air source 140 for removing dust and fines from inlet assembly 130. Instead of a cyclone separator, other dust collection equipment, such as a baghouse or bag filter, may be used.

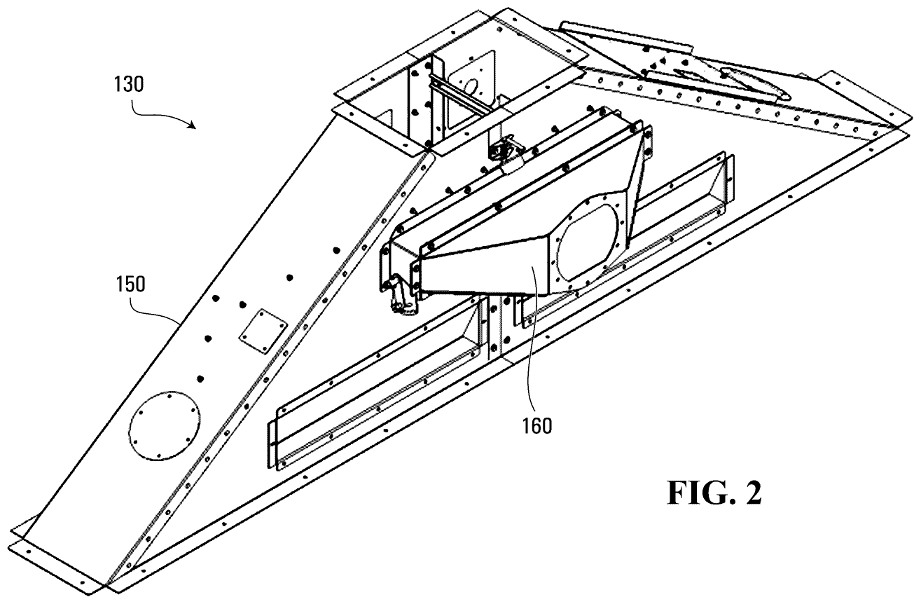

FIG. 2 is a perspective view of inlet assembly 130 for mounting onto roof of grain dryer 120. Inlet assembly 130 includes dryer inlet aspirator 150 and air source coupler 160. Air source coupler 160 is configured to connect dryer inlet aspirator 150 to air source 140.

In some embodiments, air source 140 may couple directly to dryer inlet aspirator 150.

Dryer inlet aspirator 150 may use air flow to remove material other than grain from the inlet of grain dryer 120. It will be appreciated that removing material other than grain prior to grain entering grain dryer 120 may improve drying efficiency and reduce fugitive dust emissions leaving grain dryer 120. As well, removing material other than grain may reduce the likelihood of hazardous conditions forming during the drying process.

In addition to removing material other than grain, dryer inlet aspirator 150 may further be configured to prevent grain from exiting dryer inlet aspirator 150 through air source coupler 160 or other undesired inlets or outlets of dryer inlet aspirator 150. For example, dryer inlet aspirator 150 may be configured to prevent grain from exiting an air inlet and air outlet of grain dryer inlet aspirator 150.

Dryer inlet aspirator 150 may also be configured to operate while full, such that grain does not need to be “free flowing” through dryer inlet aspirator 150 or dryer system 100′. Dryer inlet aspirator 150 may receive grain input from a variety of different filling equipment (not shown).

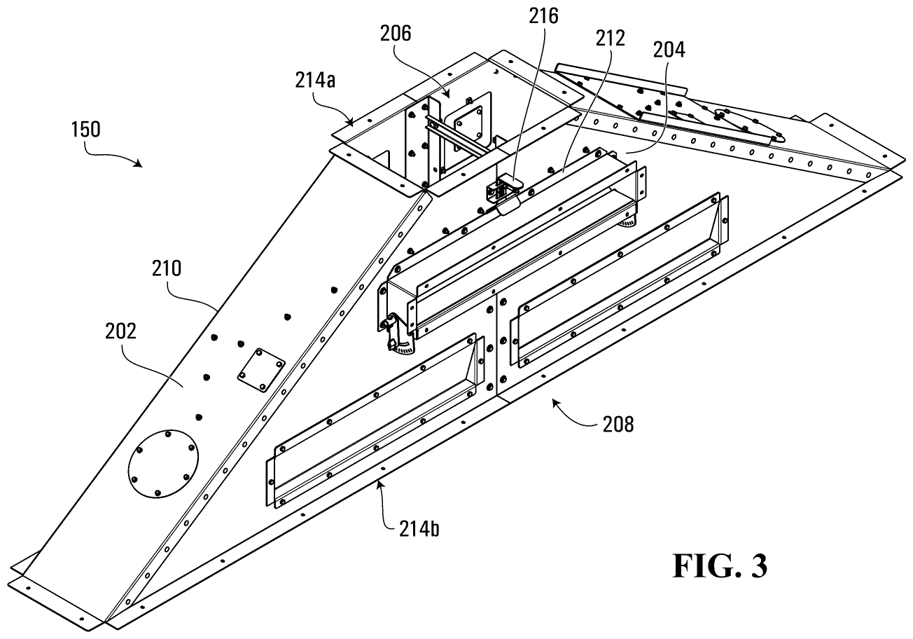

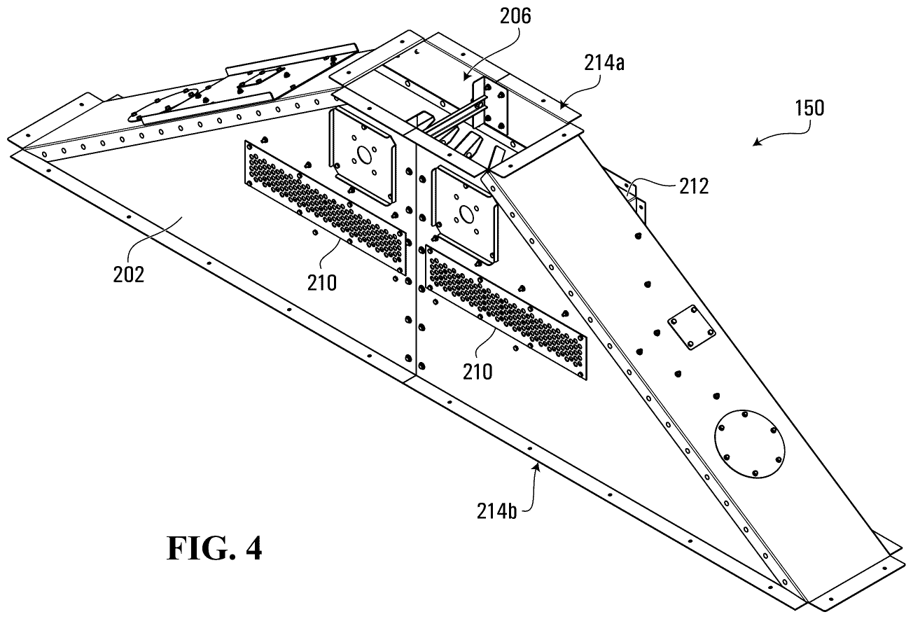

FIGS. 3-4 are perspective views of dryer inlet aspirator 150. Dryer inlet aspirator 150 includes an aspirator housing 202 and a bypass airstream assembly 204.

Aspirator housing 202 may be in the form of a trapezoidal prism, such that the longitudinal cross-section of dryer inlet aspirator 150 is trapezoidal. Aspirator housing 202 may also be in the form of cube, cuboid or another shape. Aspirator housing may be formed of a metal, alloy or plastic.

Dryer inlet aspirator 150 is configured to remove material other than grain from the inlet of grain dryer 120. Dryer inlet aspirator 150 includes a grain input 206, a grain output 208, an air inlet 210 and an air outlet 212, each formed in aspirator housing 202. Grain input 206 is formed in an upper side of aspirator housing 202, while grain output 208 is formed in a bottom side of aspirator housing 202, opposite grain input 206. Air inlet 210 and air outlet 212 may also be formed on opposite sides of aspirator housing 202, such as on the trapezoidal faces of aspirator housing 202.

Grain input 206 may be connected to a grain source, which may be mounted on the upper side of dryer inlet aspirator 150 using upper installation edges 214a. Upper installation edges 214a may surround the perimeter of grain input 206 and include screw holes for affixing grain source to dryer inlet aspirator 150. Grain source includes filling equipment (not shown). Grain source may include an auger or conveyor for feeding grain into grain input 206. Grain source may be controllable by dryer inlet aspirator 150 to maintain a certain level of grain in dryer inlet aspirator 150. Alternatively, grain source may include a downspout filling hopper, such that grain may always be input into grain input 206 by the force of gravity. Grain source may also include other filling equipment.

Grain output 208 is disposed on an opposite side of dryer inlet aspirator 150 from grain input 206. Grain fed into dryer inlet aspirator 150 may be fed into grain input 206 from grain source to enter aspirator housing 202, pass through aspirator housing 202 and exit aspirator housing 202 through grain output 208 into roof of grain dryer 120. As will be appreciated, grain may be urged through dryer inlet aspirator 150 by gravity.

Air inlet 210 and air outlet 212 are used to distribute an air stream through dryer inlet aspirator 150. In particular, air inlet 210 is used for drawing air into dryer inlet aspirator 150, while air outlet 212 is used for expelling air from aspirator housing 202. Air stream may be generated using an air source, such as a blower. Air inlet 210 may be disposed opposite air outlet 212.

Dryer inlet aspirator 150 may also include one or more air inlets 210, which may be distributed across one or more sides of aspirator housing 202 to draw input air into multiple locations of dryer inlet aspirator 150.

Similarly, dryer inlet aspirator 150 may include one or more air outlets 212, which may be distributed across one or more sides of aspirator housing 202 to expel output air from multiple locations of aspirator housing 202.

Bypass airstream assembly 204 is connected to aspirator housing 202 and may be used to modulate air flow in dryer inlet aspirator 150. Bypass airstream assembly 204 receives air output from aspirator housing 202. As noted above, air output exits aspirator housing 202 through air outlet 212. Air outlet 212 of dryer inlet aspirator 150 may be connected to an air inlet of bypass airstream assembly 204.

Bypass airstream assembly 204 is connected to air source 140 using air source coupler 160. Air source 140 may be connected to bypass airstream assembly 204 opposite aspirator housing 202. In particular, air source coupler 160 may be connected to an outlet of bypass airstream assembly 204, which may be disposed opposite the air inlet of bypass airstream assembly 204 and thus air outlet 212. Air source 140 may thus couple to air source coupler 160 opposite aspirator housing 202. As noted above, air source 140 may be a blower.

Inlet assembly 130 may also include a dust collection system (not shown), such as a cyclone separator. Dust collection system may be connected to bypass airstream assembly 204, or may be integrated at the discharge of air source 140. For example, cyclone separator may be connected to blower output through ductwork piping. Alternatively, dust collection system may be integrated with air source 140.

It will be understood that in a typical configuration, air source 140 draws air into dryer inlet aspirator 150 through air inlet 210, through the interior of aspirator housing 202, out of aspirator housing 202 through air outlet 212, through bypass airstream assembly 204 and through air source coupler 160 to air source 140.

Bypass airstream assembly 204 may allow the velocity of air flowing through dryer inlet aspirator 150, and in particular the velocity of air flowing through aspirator housing 202, to be modulated. In one configuration, air source 140 draws air through air inlet 210, aspirator housing 202, air outlet 212, bypass airstream assembly 204, through air source coupler 160 and into air source 140. In another configuration, air source 140 may also draw additional air through a secondary air path. Air in this secondary path may only pass through air source coupler 160 and bypass airstream assembly 204. In particular, bypass airstream assembly 204 may be used to introduce a secondary air path into dryer inlet aspirator 150, allowing air into the dryer inlet aspirator 150 that only passes through bypass airstream assembly 204 and that does not pass through aspirator housing 202. As such, this secondary or bypass air path may reduce the overall pressure on grain within aspirator housing 202 and help prevent whole grain from being inadvertently drawn into the air stream generated by air source 140.

Dryer inlet aspirator 150 may be mounted onto roof of grain dryer 120 using lower installation edges 214b formed in aspirator housing 202. Lower installation edges 214b may surround the perimeter of grain output 208 and include screw holes for affixing dryer inlet aspirator 150 to roof of grain dryer 120.

As noted above, a longitudinal cross-section of dryer inlet aspirator 150, and in particular aspirator housing 202, may be trapezoidal, such that aspirator housing 202 is in the form of a trapezoidal prism. A trapezoidal cross-section of dryer inlet aspirator 150 may allow dryer inlet aspirator 150 to be installed onto roof of grain dryer 120 without increasing the overall height of dryer system 100′ relative to another grain dryer system 100 that does not include dryer inlet aspirator 150. For example, dryer inlet aspirator 150 may replace an existing hopper already installed on roof of grain dryer 120, which may also include a trapezoidal longitudinal cross-section. In this way, dryer inlet aspirator 150 may be integrated with grain dryer 120.

Dryer inlet aspirator 150 may further include lever 216. As will be discussed in further detail below, lever 216 may allow input grain 230 in dryer inlet aspirator 150 to be manually adjusted, such as to increase or decrease input grain 230 for different crops. Lever 216 may also be connected to a catch pin, which may be used retain lever 216 in a fixed position.

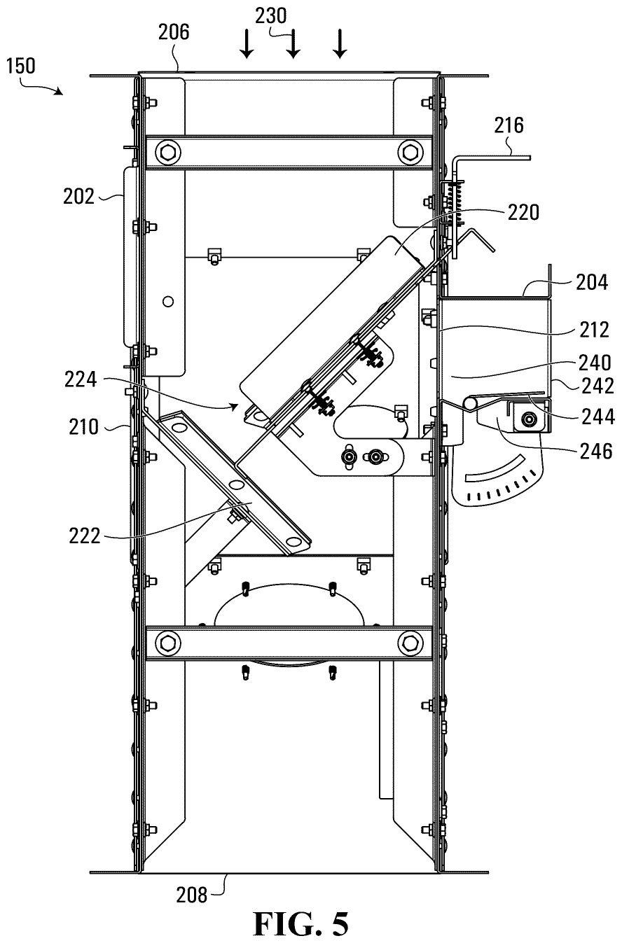

FIG. 5 illustrates a cross-section of dryer inlet aspirator 150, which includes aspirator housing 202 and bypass airstream assembly 204. Additionally, air source coupler 160 may allow dryer inlet aspirator 150 to connect to air source 140.

A main distribution plate 220 and a lower distribution plate 222 are disposed within aspirator housing 202. Lower distribution plate 222 is disposed beneath main distribution plate and positioned at a deflection angle 225 relative to main distribution plate 220.

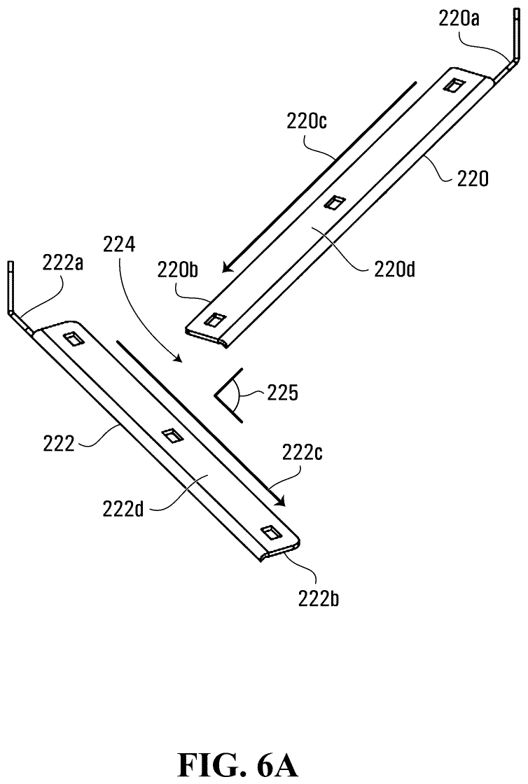

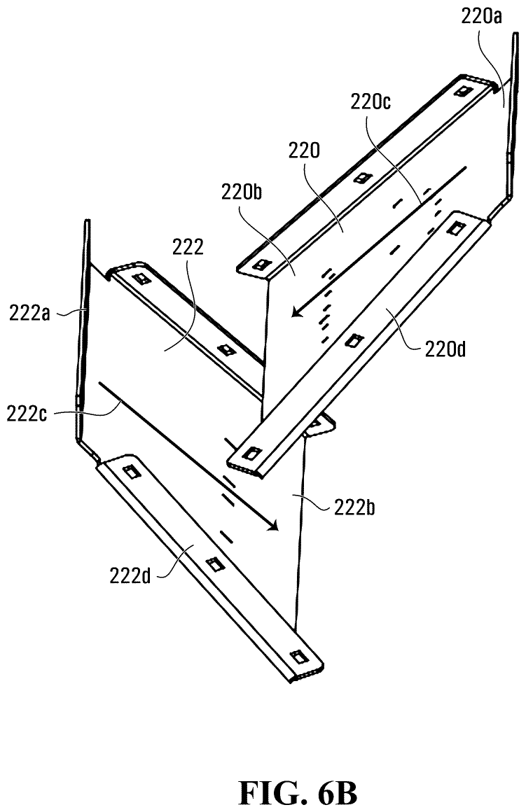

FIGS. 6A-6B depict a cross-section and perspective view of main distribution plate 220 and lower distribution plate 222 in aspirator housing 202.

Main distribution plate 220 includes an upper edge 220a oriented above a lower edge 220b. Main distribution plate 220 is oriented at an angle relative to aspirator housing 202. Due to the force of gravity, grain falling onto main distribution plate 220 from grain input 206 will be guided by main distribution 220 in a first direction 220c, namely in the direction defined from upper edge 220a to lower edge 220b.

Similarly, lower distribution plate 222 include an upper edge 222a oriented above a lower edge 222b. Lower distribution plate 222 is also oriented at an angle relative to aspirator housing 202. Also due to the force of gravity, grain falling onto lower distribution plate 222 will be guided by lower distribution plate 222 in a second direction 222c, namely in the direction defined from upper edge 222a to lower edge 222b.

It will be appreciated that deflection angle 225 of lower distribution plate 222 relative to main distribution plate 220 is a function of first direction 220c of main distribution plate 220 relative to second direction 222c of lower distribution plate 222. Deflection angle 225 of lower distribution plate 222 relative to main distribution plate 220 may be 90 degrees, such that main distribution plate 220 and lower distribution plate 222 are perpendicular. Deflection angle 225 may also be less than or more than 90 degrees.

Main distribution plate 220 and lower distribution plate 222 are both generally trapezoidal. However, main distribution plate 220 and lower distribution plate 222 may also be rectangular, triangular or some other shape. Main distribution plate 220 and lower distribution plate 222 may be the same or different shapes.

Main distribution plate 220 may also include edge guards 220d to prevent grain from spilling over edges of main distribution plate 220 other than lower edge 220b. Edge guards may be formed by raising edges of main distribution plate 220 other than lower edge 220b, and in particular edges of main distribution plate 220 approximately parallel to first direction 220d.

Lower distribution plate 222 may similarly include edge guards 222d formed by raising edges of lower distribution plate 222 other than lower edge 222b, and in particular edges of lower distribution plate 222 approximately parallel to second direction 222c.

In some other embodiments, main distribution plate 220 and lower distribution plate 222 may not include edge guards 220d and 222d, respectively, to allow for excess input grain 230 to spill over the sides of main distribution plate 220 and lower distribution plate 222 and reduce the risk of plugging filling equipment.

The lengths of upper edge 220a and lower edge 220b of main distribution plate 220 may be approximately 40 and 60 inches, respectively. However, the lengths of upper edge 220a and lower edge 220b may also be more or less than 40 and 60 inches, respectively.

Similarly, the lengths of upper edge 222a and lower edge 222b of lower distribution plate 222 may be approximately 60 and 80 inches, respectively, or more or less than 60 and 80 inches, respectively.

Due to deflection angle 225, first direction 222c of main distribution plate 220 points towards lower distribution plate 222, with main distribution plate 220 terminating in lower edge 220b just above lower distribution plate 222. Lower edge 220b of main distribution plate 220 is spaced from lower distribution plate 222, such that a choke point 224 is formed between lower edge 220b and lower distribution plate 222. In particular, choke point 224 is a gap formed between lower edge 220b and lower distribution plate 222, for a stream of input grain 230 to pass through. Choke point 224 between lower edge 220b and lower distribution plate 222 constricts the flow of grain traveling from main distribution plate 220 in first direction 220c to lower distribution plate 222. Since choke point 224 is defined by the spacing between lower edge 220b of main distribution plate 220 and the face of lower distribution plate 222, the dimensions of choke point 224 are defined by the length of lower edge 220b, the length of lower distribution plate 222 and spacing between lower edge 220b and lower distribution plate 222. Typically, the length of lower edge 220b may be less than the length of lower distribution plate 222, such that the length of choke point 224 may only be determined by the length of lower edge 220b, e.g. approximately 60 inches, or more or less than 60 inches depending on the length of lower edge 220b. Width of choke point 224 may be approximately 3 inches, or also more than or less than 3 inches. For example, width of choke point 224 may be 3 inches and length of choke point 224 may be 32.5 inches.

Input grain 230 enters aspirator housing 202 through grain input 206. Main distribution plate 220 receives input grain 230 from grain input 206 and, due to the orientation of main distribution plate 220 relative to lower distribution plate 222, guides stream of input grain 230 in first direction 220c towards lower edge 220b and into choke point 224. Due to the dimensions of choke point 224, choke point 224 may constrict stream of input grain 230 passing between lower edge 220b of main distribution plate 220 and lower distribution plate 222.

Lower distribution plate 222 receives stream of input grain 230 from main distribution plate 220 after it has travelled through choke point 224. Lower distribution plate 222 may also receive input grain 230 directly from grain input 206. Due to the orientation of lower distribution plate 222, lower distribution plate 222 further guides stream of input grain 230 in second direction 222c, towards lower edge 222b and grain dryer output 208. As well, lower distribution plate 222 may also guide stream of input grain 230 received directly from grain input 206 in second direction 222c, toward choke point 224. Input grain 230 passing through grain output 208 is distributed into roof of grain dryer 120.

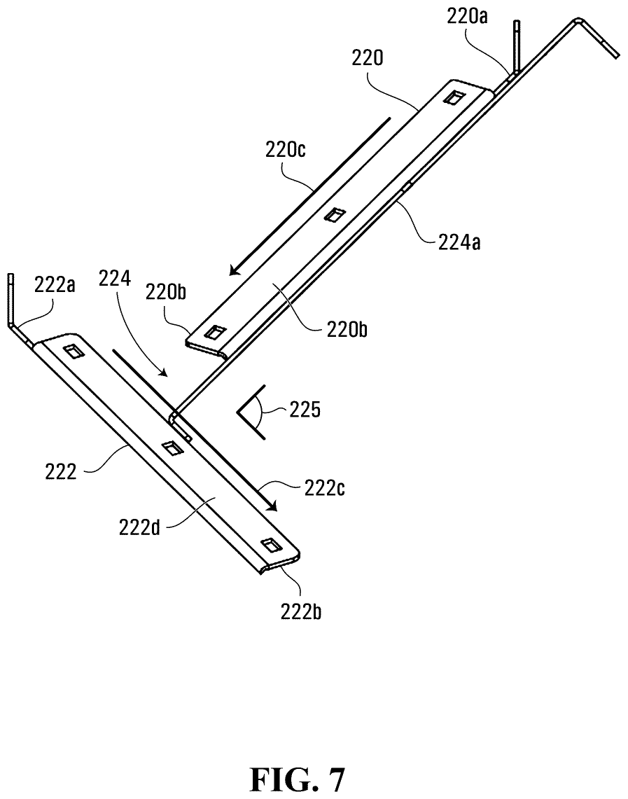

As depicted in FIG. 7, choke point 224 may also include an adjustable plate 224a disposed below main distribution plate 220. Adjustable plate 224a may be used modify choke point 224 by increasing or decreasing stream of input grain 230 travelling from main distribution plate 220 to lower distribution plate 222.

Adjustable plate 224a may be oriented parallel to main distribution plate 220. Adjustable plate 224a may be extendable towards lower distribution plate 222 and fully retractable to be completely covered by main distribution plate 220. Adjustable plate 224a may also be adjusted to extend fully across choke point 224, in addition to being adjusted to retract completely under main distribution plate 220. Fully extended, adjustable plate 224a may contact lower distribution plate 222. Fully retracted, adjustable plate 224a may be completely covered by main distribution plate 220, such that adjustable plate 224a does not affect stream of input grain 230 passing through choke point 224. In this way, the quantity of input grain 230 passing through choke point 224 can be adjusted. For example, adjustable plate 224a may be used to further constrict stream of input grain 230 passing through choke point 224. Adjustable plate 224a may be used to vary width of choke point 224 from 3 inches to 1 inch, or alternatively vary width of choke point 224 from its maximum width (i.e. with adjustable plate 224 fully retracted) to zero (i.e. with adjustable plate fully extended to lower distribution plate 222).

Choke point 224 may be adjusted manually by lever 216 accessible outside aspirator housing 202. Lever 216 may be lifted to retract adjustable plate 224a and depressed to extend adjustable plate 224a. It will be appreciated that lever 216 may be connected to adjustable plate 224a using a variety of possible coupling mechanisms, such that lifting or depressing lever 216, respectively, may retract or extend adjustable plate 224a. An end of lever 216 may be disposed outside aspirator housing 202, such that lever 216 is accessible outside dryer inlet aspirator 150. Other methods of retracting or extending extend adjustable plate 224a may also be possible. Adjustable plate 224a may be adjustable (extended or retracted) to one of three possible position, such that width choke point 224 is 1 inch, 2 inches or 3 inches. Alternatively, adjustable plate 224a may be adjusted to only two positions, or instead to more than three positions.

Adjustable plate 224a may be generally trapezoidal. However, adjustable plate 224a may also be rectangular, triangular or some other shape. Adjustable plate 224a may have the same dimensions as main distribution plate 220, or instead may have smaller or larger dimensions than main distribution plate 220. For example, a lower edge of adjustable plate 224a may be shorter than lower edge 220b of main distribution plate 220.

With reference to FIG. 5, input grain 230 is deposited into dryer inlet aspirator 150 using filling equipment (not shown). Input grain 230 may be deposited into dryer inlet aspirator 150 using a downspout setup from a distributor, such as a grain leg or elevator. Input grain 230 may be free flowing through dryer inlet aspirator 150 during the initial filling of dryer inlet aspirator 150 and grain dryer 120. During operation, the downspout setup may keep dryer inlet aspirator 150 constantly full, allowing grain dryer 120 to remain completely full throughout its operation.

It will be appreciated that it is important to prevent grain from being removed or sucked out of dryer inlet aspirator 150 by air source 140, such as through air inlet 210 or air outlet 212. This can be achieved by ensuring that grain does not accumulate close to either air inlet 210 or air outlet 212.

Air inlet 210 may be disposed beneath lower distribution plate 222 and air outlet 212 may be disposed opposite air inlet 210 and beneath main distribution plate 220. In other embodiments, air outlet 212 may be disposed beneath lower distribution plate 222 and air inlet 210 may be disposed beneath main distribution plate 220.

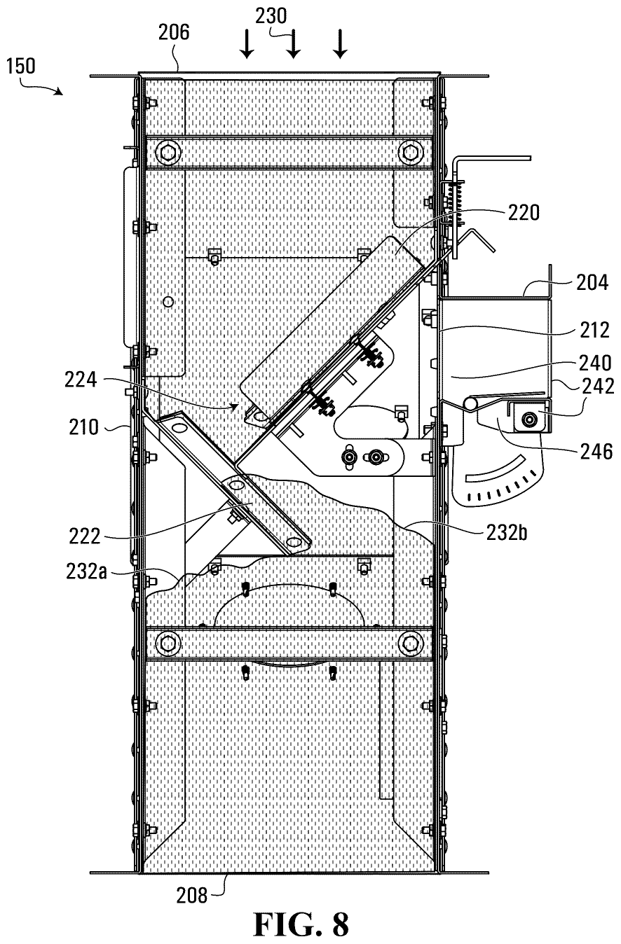

FIG. 8 depicts a cross-section of dryer inlet aspirator 150, in which aspirator housing 202 is filled by input grain 230 according to a downspout setup. Grain level 232a accumulates below lower distribution plate 222 on top of roof of grain dryer 120. Similarly, grain level 232b also accumulates below lower distribution plate 222 on top of roof of grain dryer 120. It will be understood that grain levels 232a, 232b are contiguous and form the total grain level accumulating on roof of grain dryer 120.

Due to the vertical relationships between air inlet 210, air outlet 212, main distribution plate 220 and lower distribution plate 222, grain level 232a remains below air inlet 210 and grain level 232b remains below air outlet 212, even in situations where dryer inlet aspirator 150 is full or input grain 230 is free flowing through dryer inlet aspirator 150. In addition, the mechanical and physical properties of the grain, and in particular the angle of repose of the grain accumulating on roof of grain dryer 120, also help ensure that grain levels 232a, 232b in dryer inlet aspirator 150 remain below air inlet 210 and air outlet 212, respectively. In situations where the type of input grain 230 has a relatively low density, adjustments to choke point 224 may be available to ensure that grain levels 232a, 232b remain below air inlet 210 and air outlet 212. In particular, adjustable plate 224 may be retracted or extended as necessary to ensure that grain levels 232a, 232b remain at the appropriate height.

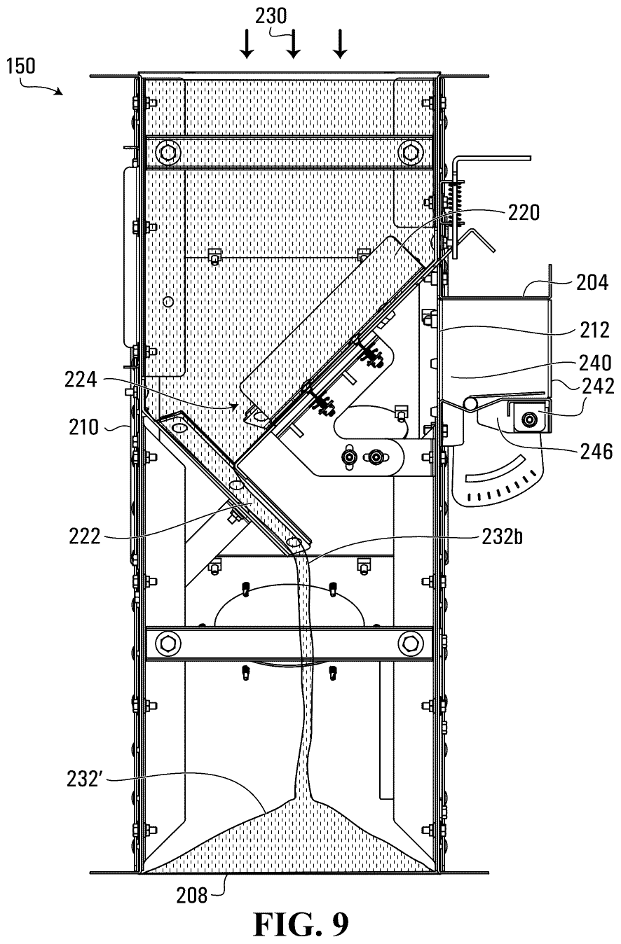

As depicted in FIG. 9, input grain 230 may alternatively be deposited into dryer inlet aspirator 150 using an auger or conveyor (not shown). Auger or conveyor may fill dryer inlet aspirator 150 and grain dryer 120 until grain dryer 120 commands auger or conveyor to shut down, such as when grain dryer 120 is full. As grain dryer 120 unloads grain during operation, grain level 232′ in dryer inlet aspirator 150 and grain dryer 120 drops until grain dryer 120 commands auger or conveyor to begin filling dryer inlet aspirator 150 and grain dryer 120 again. During this filling operation, grain may be free flowing through dryer inlet aspirator 150 until grain level 232′ reaches a point that it backs up into the upper portion of dryer inlet aspirator 150, above main distribution plate 220 and lower distribution plate 222.

Grain level 232′ in dryer inlet aspirator 150 may be controlled by auger or conveyor to remain below air inlet 210 and air outlet 212 at all times.

With reference to FIG. 5 again, bypass airstream assembly 204 also includes secondary air inlet 240, secondary air outlet 242, air velocity adjustment baffle 244 and bypass air slots 246. Secondary air inlet 240 is connected to air outlet 212 of dryer inlet aspirator 150, while secondary air outlet 242 may be connected to air source coupler 160 and air source 140. Secondary air outlet 242 may be disposed opposite secondary air inlet 240.

It will be understood that air only exits dryer inlet aspirator 150 through secondary air outlet 242. Air may be drawn out of dryer inlet aspirator 150 through secondary air outlet 242 by air source 140, such as a blower, Into air source coupler 160. However, air exiting air outlet 212 still remains within dryer inlet aspirator 150, exiting aspirator housing 202 into bypass airstream assembly 204.

Air velocity adjustment baffle 244 may be used to adjust the velocity of air exiting air outlet 212 into bypass airstream assembly 204, and is adjustable between a raised position and a lowered position. In particular, air velocity adjustment baffle 244 may be raised from its lowered position such that it interrupts the flow of air exiting air outlet 212. Air velocity adjustment baffle 244 may also be raised to one or more intermediate positions between raised position and lowered position.

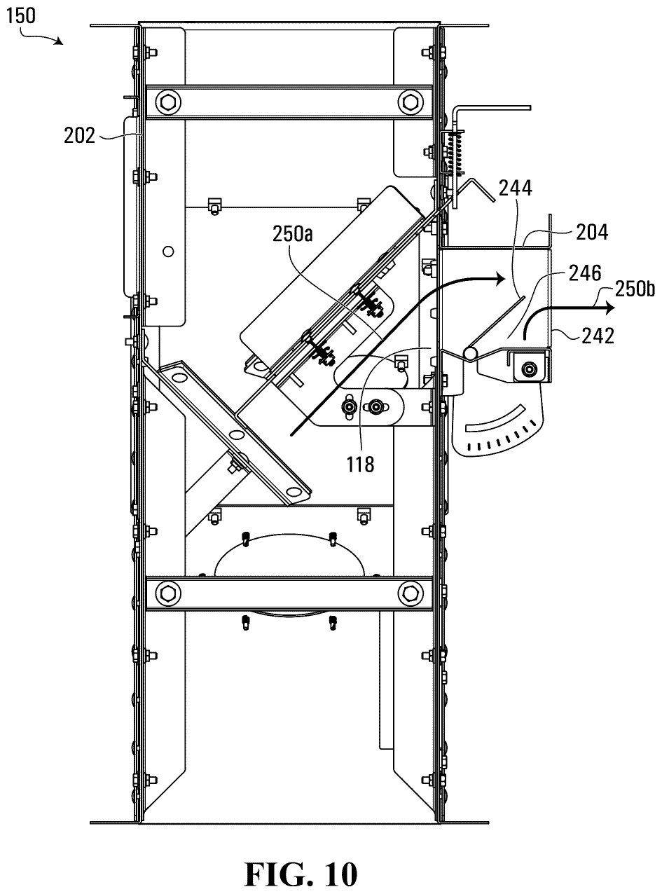

It will be appreciated that when air velocity adjustment baffle 244 is raised, bypass air slots 246 may be exposed. Bypass air slots may be disposed beneath air velocity adjustment baffle 244 and may be used to introduce a bypass airstream into bypass airstream assembly 204. As depicted in FIG. 10, primary airflow 250a travels through aspirator housing 202 and enters bypass airstream assembly 204 through secondary air inlet 240. Primary airflow 250a eventually exits bypass airstream assembly 204 through secondary air outlet 242 towards air source 140. Secondary air outlet 242 may also be connected to a dust collection system. In addition, secondary airflow 250b may also enter bypass airstream assembly 204 through bypass air slots 246 if air velocity adjustment baffle 244 is raised to uncover bypass air slots 246. Secondary airflow 250b may also eventually exit bypass airstream assembly 204 through secondary air outlet 242 towards air source 140. In this configuration, the total airflow 250a, 250b in bypass airstream assembly 204 is greater than the total airflow in dryer inlet aspirator 150, which is limited only to primary airflow 250a. The addition of secondary airflow 250b into bypass airstream assembly 204 may reduce the overall pressure on grain in dryer inlet aspirator 150, and in particular within aspirator housing 202, and further help prevent whole grains from being inadvertently drawn into primary airflow 250a and air source 140 while still maintaining some cleaning effect.

Uncovering bypass air slots 246 may thus cause a bypass airstream, namely secondary airflow 250b, to enter bypass airstream assembly 204 through bypass air slots 246. Bypass airstream may exit bypass airstream assembly 204 through secondary air outlet 242 without contacting input grain 230.

However, if velocity adjustment baffle 244 is lowered such that it covers bypass air slots 246, bypass airstream, namely secondary airflow 250b, may be unable to enter bypass airstream assembly 204. In this configuration, grain in dryer inlet aspirator 150 may not experience an overall reduction in pressure, since primary airflow 250a may be the only airstream drawn into air source 140.

It will be appreciated that by raising velocity adjustment baffle 244, both the velocity of primary airflow 250a and the pressure on grain in dryer inlet aspirator 150 may be modulated.

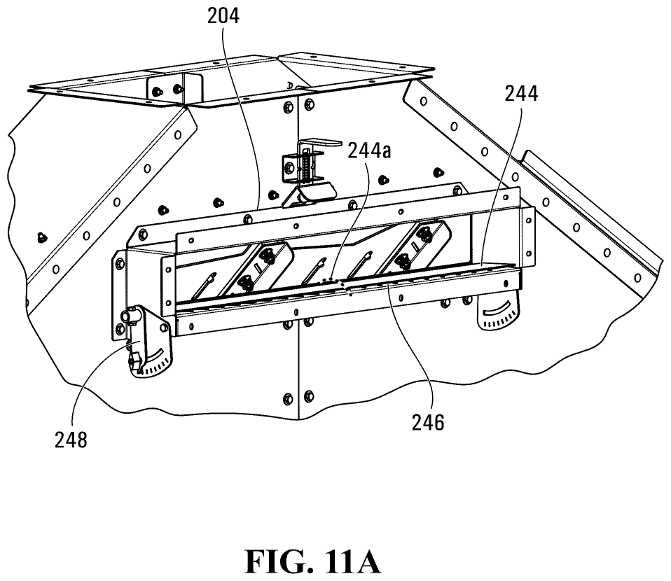

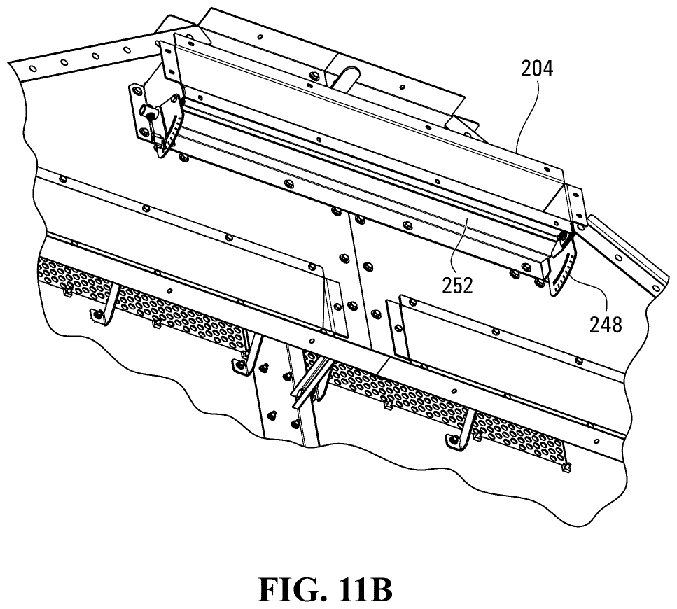

FIGS. 11A-11B are perspective views of bypass airstream assembly 204 connected to air outlet 212, depicting velocity adjustment baffle 244 in a lowered position over bypass air slots 246. It will be appreciated that velocity adjustment baffle 244 may also be disposed in a raised position above bypass air slots 246.

Velocity adjustment baffle 244 may be controlled by velocity adjustment lever 248, which may be used to lower or raise velocity adjustment baffle 244 at varying degrees to form velocity adjustment angle 244a between velocity adjustment baffle 244 and bypass air slots 246. For example, velocity adjustment baffle 244 may only be raised partially from lowered position over bypass air slots 246 (i.e. velocity adjustment angle 244a may be 10 degrees), such that only limited secondary airflow 250b is introduced into bypass airstream assembly 204 through bypass air slots 246. As well, since velocity adjustment baffle 244 may only be raised partially from lowered position over bypass air slots 246 (i.e. to an intermediate position), velocity adjustment baffle 244 may only partially affect the velocity of primary airflow 250a travelling into bypass airstream assembly 204 through secondary air inlet 240. Alternatively, velocity adjustment baffle 244 may be raised significantly above bypass air slots 246 (i.e. velocity adjustment angle 244a may be 45 degrees or more), such that a significant secondary airflow 250b is introduced into bypass airstream assembly 204 through bypass air slots 246 and the velocity of primary airflow 250a is significantly reduced by raised velocity adjustment baffle 244. It will be understood that velocity adjustment baffle 244 may be raised or lowered such that velocity adjustment angle 244a is between 0 and 90 degrees. Alternatively, velocity adjustment baffle 244 may be raised or lowered such that velocity adjustment angle 244a is between 0 and 180 degrees.

Bypass airstream assembly 204 may also include bypass cover 252, which may be used to cover or expose bypass air slots 246. When configured to expose bypass air slots 246, velocity adjustment baffle 244 and bypass air slots 246 may operate as described above, such that uncovering bypass air slots 246 by raising velocity adjustment baffle 244 may introduce secondary airflow 250b into bypass airstream assembly 204. However, when configured to cover bypass air slots 246, velocity adjustment baffle 244 may be raised without introducing secondary airflow 250b into bypass airstream assembly 204, since bypass air slots 246 will remain covered by bypass cover 252. In such a configuration, velocity adjustment baffle 244 may be used to modulate the velocity of primary airflow 250a in dryer inlet aspirator 150 without introducing secondary airflow 250b and reducing the overall pressure on grain in dryer inlet aspirator 150.

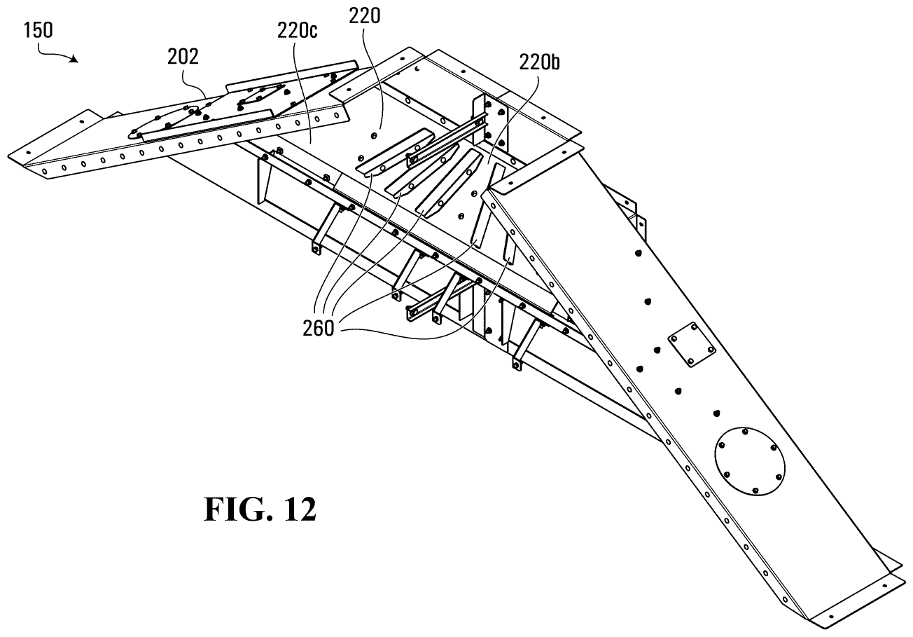

FIG. 12 depicts a cutaway view of dryer inlet aspirator 150, and in particular aspirator housing 202. As already discussed above, dryer inlet aspirator 150 includes main distribution plate 220 for distributing stream of input grain 230 from grain input 206 towards choke point 224 and eventually grain output 208. Main distribution plate 220 also distributes stream of input grain 230 onto lower distribution plate 222.

Main distribution plate 220 may include spreader baffles 260 to help distribute grain more evenly across choke point 224. Distributing grain more evenly across choke point 224 may ensure that stream of input grain 230 can pass through choke point 224 at a greater rate, without unnecessarily backing up above main distribution plate 220 and lower distribution plate 222. In addition, since stream of input grain 230 may pass through choke point 224 more evenly after passing through spreader baffles 260, input grain 230 may accumulate more evenly on the roof of grain dryer 120.

Spreader baffles 260 may be elevated from main distribution plate 220 by 5 centimeters and may each be 0.275 centimeters thick. Alternatively, spreader baffles 260 may be elevated less than or more than 5 centimeters and may be less than or more than 0.275 centimeters thick. Spreader baffles may each also have different dimensions. In addition, spreader baffles 260 may be rectangularly shaped. Spreader baffles 260 may further include tapered edges to ensure that grain does not accumulate on the upper ends of spreader baffles 260 and to help streamline grain towards choke point 224. Different shapes of spreader baffles 260 may also be possible. For example, spreader baffles could be tapered such that one side is taller than the other, or could be round or triangularly shaped.

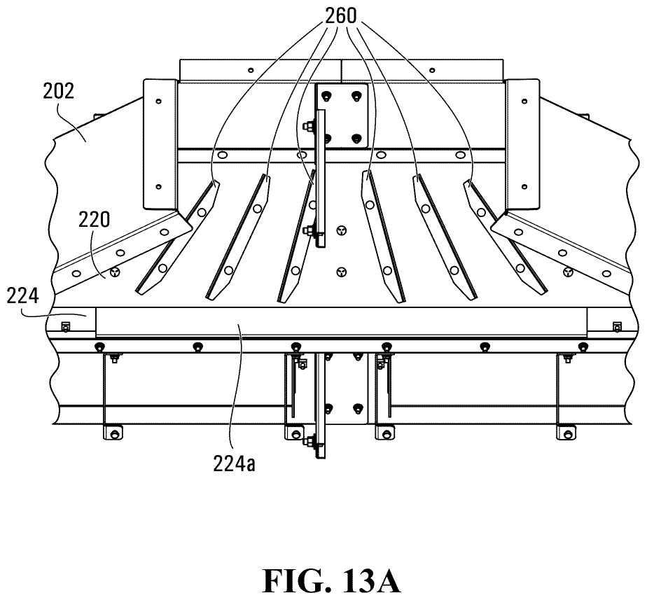

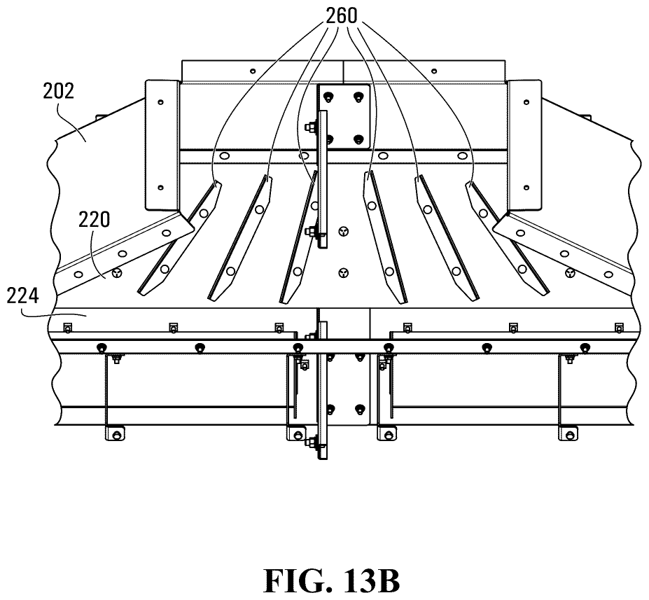

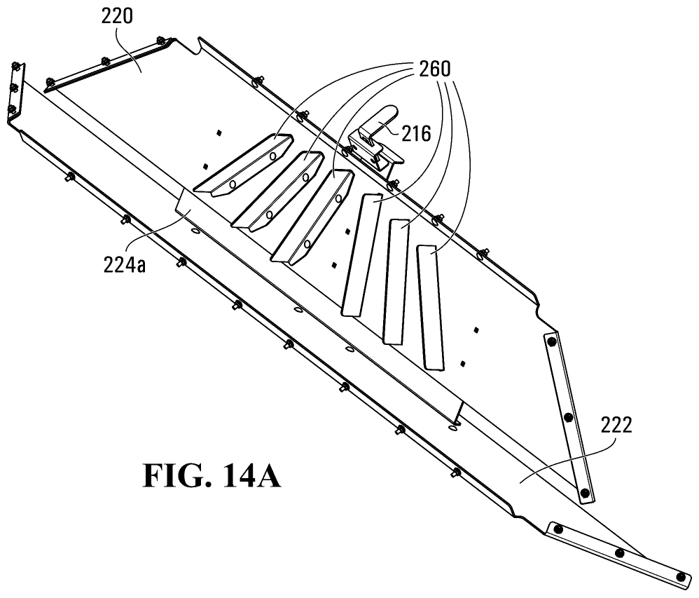

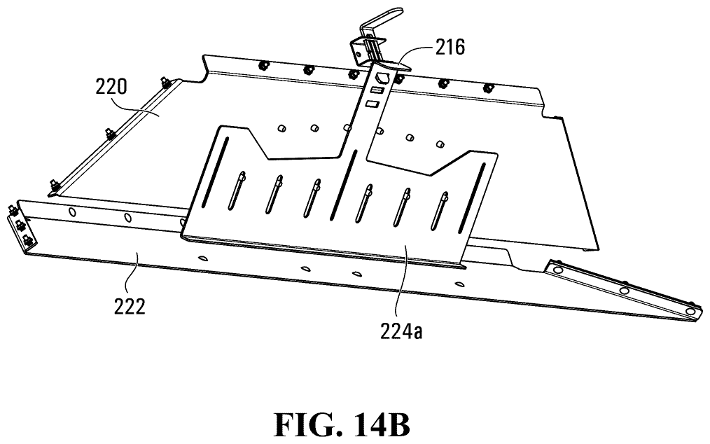

FIGS. 13A-13B depict a top-down view of dryer inlet aspirator 150, and in particular main distribution plate 220 and spreader baffles 260. FIGS. 14A-14B depict a perspective view of the interior of dryer inlet aspirator 150, including main distribution plate 220, lower distribution plate 222, adjustable plate 224a and spreader baffles 260, as well as lever 216 for allowing stream of input grain 230 in dryer inlet aspirator 150 to be manually adjusted.

Spreader baffles 260 may extend from the upper edge 220a of main distribution plate 220 towards the lower edge 220b of main distribution plate 220 and choke point 224. Spreader baffles 260 may be oriented in such a way that grain is spread across the entire width of main distribution plate 220 as it travels from upper edge 220a to lower edge 222b and choke point 224 under the force of gravity. Main distribution plate 220 may include six spreader baffles 260, or alternatively main distribution plate 220 may include fewer or more spreader baffles 260. It will be appreciated that various configurations, shapes and sizes of spreader baffles 260 may be possible.

As discussed above, choke point 224 also includes adjustable plate 224a, which may be disposed below main distribution plate 220. FIG. 13A depicts adjustable plate 224a configured to extend across choke point 224, such that some or all of grain may be blocked by adjustable plate 224a from passing through choke point 224.

Adjustable plate 224a may be retracted and extended using lever 216. FIG. 13B depicts adjustable plate 224a configured to retract from choke point 224, such that adjustable plate 224a is completely covered by main distribution plate 220 to allow grain to pass unobstructed through choke point 224.

In some further configurations, lever 216 may be used to only partially extend or retract adjustable plate 224a, such that only a portion of choke point 224 is unobstructed to allow grain to pass through.

In preferred embodiments, adjustable plate 224a is disposed below and in parallel with main distribution plate 220. In some further embodiments, adjustable plate 224a may be disposed at an angle relative to main distribution plate 220. Although main distribution plate 220 may still extend to block choke point 224 and retract to open choke point 224, adjustable plate 224a may be oriented to be non-parallel with main distribution plate 220, such as to form a non-zero angle with main distribution plate 220.

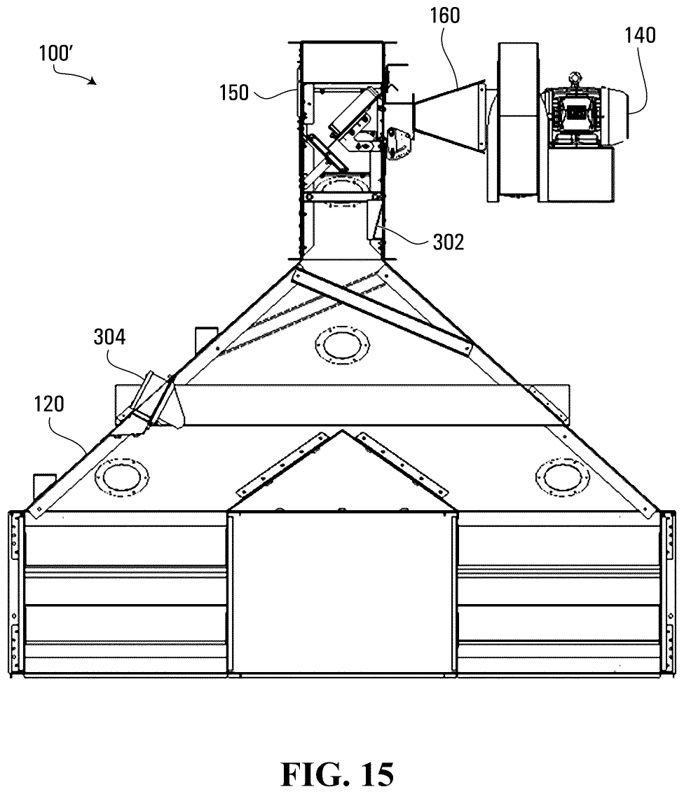

In certain grain type and filling scenarios, the positioning of main distribution plate 220 and lower distribution plate 222 could create uneven filling of grain dryer 120, and potentially reduce grain moisture sensor contact, creating poor drying conditions. As depicted in FIG. 15, a deflection plate 302 may also be included below main distribution plate 220 and lower distribution plate 222 to ensure even filling of columns in grain dryer 120 and to maintain adequate grain contact to inlet moisture sensor 304. Deflection plate 302 may redirect grain to center of grain dryer 120.

Of course, the above-described embodiments are intended to be illustrative only and in no way limiting. The described embodiments are susceptible to many modifications of form, arrangement of parts, details and order of operation. The invention is intended to encompass all such modification within its scope, as defined by the claims.

What is claimed is:

1. A dryer inlet aspirator for pre-cleaning grain, said dryer inlet aspirator comprising:
an aspirator housing;
an air inlet and an air outlet formed in said aspirator housing, for distributing an air stream through said dryer inlet aspirator;
a grain input formed in said aspirator housing, for said grain to enter said dryer inlet aspirator;
a grain output formed in said aspirator housing, for said grain to exit said dryer inlet aspirator; and
a main distribution plate for guiding a stream of said grain in a first direction within said dryer inlet aspirator;
a lower distribution plate beneath said main distribution plate, positioned at an angle relative to said main distribution plate to receive said stream of said grain and further guide said stream of said grain in a second direction within said dryer inlet aspirator;
wherein a lower edge of said main distribution plate is spaced from said lower distribution plate to constrict the flow of said stream of said grain from said main distribution plate to said lower distribution plate.

2. The dryer inlet aspirator of claim 1, wherein said main distribution plate includes spreader baffles to help distribute said grain more evenly across said lower edge of said main distribution plate.

3. The dryer inlet aspirator of claim 1, wherein said main distribution plate and said lower distribution plate are each trapezoidal.

4. The dryer inlet aspirator of claim 1, wherein said main distribution plate comprises edge guards formed by raising edges of said main distribution plate approximately parallel to said first direction.

5. The dryer inlet aspirator of claim 1, wherein said air inlet is disposed beneath said lower distribution plate and said air outlet is disposed opposite said air inlet and beneath said main distribution plate.

6. The dryer inlet aspirator of claim 1, wherein said lower edge of said main distribution plate is spaced approximately 3 inches from said lower distribution plate.

7. The dryer inlet aspirator of claim 1, further comprising an adjustable plate disposed below said main distribution plate and configurable to increase or decrease said stream of said grain travelling from said main distribution plate to said lower distribution plate.

8. The dryer inlet aspirator of claim 7, wherein said adjustable plate is extendable towards said lower distribution plate and said adjustable plate is fully retractable to be completely covered by said main distribution plate.

9. The dryer inlet aspirator of claim 7, further comprising a lever disposed outside said aspirator housing, for increasing and decreasing said stream of said grain travelling from said main distribution plate to said lower distribution plate.

10. The dryer inlet aspirator of claim 1, wherein said grain is free-flowing through said dryer inlet aspirator.

11. The dryer inlet aspirator of claim 1, further comprising a bypass airstream assembly disposed at said air outlet, said bypass airstream assembly comprising:
a secondary air inlet connected to said air outlet;
a secondary air outlet disposed opposite said secondary air inlet, said secondary air outlet connected to an air source;
an air velocity adjustment baffle, wherein said air velocity adjustment baffle is adjustable between a raised position and a lowered position; and
bypass air slots disposed beneath said air velocity adjustment baffle for introducing a bypass airstream into said bypass airstream assembly.

12. A dryer inlet aspirator for pre-cleaning grain, said dryer inlet aspirator comprising:
an aspirator housing;
an air inlet and an air outlet formed in said aspirator housing, for distributing an air stream through said dryer inlet aspirator;
a grain input formed in said aspirator housing, for said grain to enter said dryer inlet aspirator;
a grain output formed in said aspirator housing, for said grain to exit said dryer inlet aspirator; and
a bypass airstream assembly disposed at said air outlet, said bypass airstream assembly comprising:
a secondary air inlet connected to said air outlet;
a secondary air outlet disposed opposite said secondary air inlet, said secondary air outlet connected to an air source;
an air velocity adjustment baffle, wherein said air velocity adjustment baffle is adjustable between a raised position and a lowered position; and
bypass air slots disposed beneath said air velocity adjustment baffle for introducing a bypass airstream into said bypass airstream assembly.

13. The dryer inlet aspirator of claim 12, wherein said bypass air slots are covered when said air velocity adjustment baffle is in said lowered position and uncovered when said velocity adjustment baffle is in said raised position.

14. The dryer inlet aspirator of claim 13, wherein uncovering said bypass air slots causes said bypass airstream to enter said bypass airstream assembly through said bypass air slots and said bypass airstream to exit said bypass airstream assembly through said secondary air outlet without contacting said grain.

15. The dryer inlet aspirator of claim 13, further comprising a bypass cover to cover said bypass air slots, such that said air velocity adjustment baffle may be raised without introducing said bypass airstream through said bypass air slots.

16. The dryer inlet aspirator of claim 12, further comprising:
a main distribution plate for guiding a stream of said grain in a first direction within said dryer inlet aspirator; and
a lower distribution plate beneath said main distribution plate, positioned at an angle relative to said main distribution plate to receive a stream of said grain and further guide said stream of said grain in a second direction within said dryer inlet aspirator;
wherein a lower edge of said main distribution plate is spaced from said lower distribution plate to constrict the flow of said stream of said grain from said main distribution plate to said lower distribution plate.

17. The dryer inlet aspirator of claim 16, further comprising an adjustable plate disposed below said main distribution plate and configurable to increase or decrease said stream of said grain travelling from said main distribution plate to said lower distribution plate.

18. The dryer inlet aspirator of claim 12, wherein said grain is free-flowing through said dryer inlet aspirator.

19. The dryer inlet aspirator of claim 12, wherein said air stream is generated by a blower connected to said secondary air outlet.

20. The dryer inlet aspirator of claim 19, wherein said secondary air outlet is connected to a dust collection system.
